(19) United States
(12) Patent Application Publication
(10) Pub. No.: US 2006/0043923 A1
(43) Pub. Date: Mar. 2, 2006

(54) Performance enhancement for motor field oriented control system

(76) Inventors: Donal E. Baker, Rockford, IL (US); Curtis J. Plude, Rockton, IL (US); Gary L. Miles, Stillman Valley, IL (US); Mark W. Pfeiffer, Rockford, IL (US)

Correspondence Address: CARLSON, GASKEY & OLDS, P.C., 400 WEST MAPLE ROAD, SUITE 350, BIRMINGHAM, MI, 48009, US

(21) Appl. No.: 10/931,274

(22) Filed: Aug. 31, 2004

(51) Int. Cl. H02P 7/36

(52) U.S. Cl. 318/807

(57) ABSTRACT

A motor controller of the sort having both a transformation function for transforming three-phase feedback information into two components, and then changing an error signal for each of the two components back into three-phase correction numbers is provided with an ARCTAN correction function. The ARCTAN correction function takes in the time derivative of the changing angular position of the motor rotor, and creates a correction factor that is supplied back to the transformation function for changing the two error signals back into three. By supplying this correction ARCTAN function, the control eliminates a disturbance that may have occurred in the prior art at higher frequencies wherein both of the control loops for the two components needed to come into play to correct an error on either of the two loops.

### BACKGROUND OF THE INVENTION

This invention relates to a motor controller wherein a frequency of the motor's operation is utilized to provide a correction function for eliminating a disturbance on a two-loop control path, with the elimination of the disturbance allowing the control path to provide a single loop correction on either path.

Motor controllers are used in conjunction with motors to provide variable and controllable speed for various applications. While this invention is particularly directed for aircraft application, it is not so limited.

In aircraft applications, motor controllers are used for both low power and high power applications. Main engine starting is accomplished with a motor controller in conjunction with the main electrical power generator (acting as a motor). This is a high power application. The same is true for a motor driven hydraulic pump aircraft application. It is common practice to use the main engine starting motor controller to serve another function after the engine is started, such as driving environmental control system air compressors, which are also high power.

The hydraulic pumps and the environmental control systems are operated at very high rotational speeds so as to minimize size and weight of the motor. Associated with this high speed is a relatively high frequency required from the motor controller. Speeds of 42 krpm and 84 krpm are not unusual, and result in operating fundamental frequency up to 1300 or 1400 Hz.

One popular motor controller is the field oriented control (FOC) technology. FOC is well developed and used in synchronous and asynchronous motors around the world. A functional block diagram of the conventional FOC algorithm is illustrated in FIG. 1. FIG. 2 indicates the polarity convention used for rotational phasor quantities in the following discussions. Note that discussions are for 3 phase motor systems and standard dq terminology will be used to describe operation.

If a flux, φ, on the rotor of the synchronous motor is developed by a permanent magnet or a wound field electromagnet along a direct (d) axis, then this flux will generate a positive sinusoidal voltage in the stator winding along a quadrature (q) axis when the motor rotates in the indicated direction. The quadrature voltage leads the flux by 90 electrical degrees because of Lenz's law for magnetic circuits: V=N*dφ/dt where N is number of turns linking the flux, φ.

This voltage (V_{q}) is generally referred to as the internal back-emf of the machine. To produce mechanical power (torque) with the motor, it is necessary to drive the motor with a component of current that is in-phase with the back-emf (V_{q}). Ideally, the current would be precisely in-phase with V_{q} to achieve best mechanical power per amp. In summary, control of the q-axis current (I_{q}) provides control of the motor output torque.

Because no appreciable flux is present in the q axis, there will be no component of direct axis back-emf voltage (V_{d}) generated by the motor stator winding. It is customary to drive the synchronous motor with no d-axis current, that is I_{d}=0. It is also know by those familiar with the art, that d-axis current in a synchronous machine will provide a method to weaken (or strengthen) the main rotor flux. In asynchronous motor applications, the d-axis current provides excitation current (magnetizing current) for the motor independent from the q-axis torque producing current.

Thus, the function of the FOC motor controller is to allow independent and appropriate control of the q-axis and d-axis currents (I_{q} and I_{d}) to generate mechanical torque and to provide excitation as needed over the entire operating speed range of the motor. It is customary to incorporate a shaft position sensor to provide the angular position information necessary for the FOC operating system. The details of this disclosure are applicable to an FOC system that incorporates any shaft position sensing or sensorless means.

The primary advantage of the FOC is that it allows control and manipulation of the q-axis and d-axis components of the motor stator AC currents as if they were direct current (DC) quantities. In a sense, an FOC control makes an AC machine behave similar to a DC machine where excitation and torque are relatively independent and easily manipulated.

Referring back FIG. 1, an inverter is shown wherein the input is a set of pulse width modulated (PWM) gating pulses to drive inerter power switches. This is assumed to be a 3-phase inverter whose outputs are 3-phase voltages driving a 3-phase motor. The motor is shown driving an application as “work.” It should be understood that while this invention extends to any motor application, in disclosed embodiments, the application or “work” is an aircraft application. DC input power terminals are shown communicating with this inverter.

A feedback loop includes motor currents sensors that connect to a “Clarke” transformation block, which mathematically converts the 3-phase current signals into 2-phase quadrature AC current signals. A downstream Park transformation block then converts the 2-phase AC current signals into DC quantities. The Clark and Park transformation effectively demodulate the motor current into DC quantities where the one output is directly proportional to the amplitude of the motor's I_{q} current component and the other output is directly proportional to the motor's I_{d} current component.

The motor I_{d} and I_{q} currents are compared to their respective reference (commanded) current values by the summing junctions as shown. The resulting error currents (I_{derror} and I_{qerror}) are each processed through a proportional and integral amplifier (PI block). The resulting DC signals are the desired voltage quantities (V_{q} and V_{d}) needed to the control the inverter output voltage. These signals are DC quantities that are processed through an inverse Park transformation and an inverse Clarke transformation (Park⁻¹ and the Clarke⁻¹) to convert them back into 3-phase voltages for PWM and inverter processing. The inverter produces corresponding V_{q} and V_{d} voltages, as determined by the FOC processing; and applies them to the motor stator winding. It can be seen that the FOC control loop is effectively a 2-loop control wherein I_{q} and I_{d} are detected, processed, and reformulated as necessary to provide the desired current to the motor.

The basic control described above assumes the two loops are independent, however, the I_{q} and I_{d} control loops are not actually completely independent from one another. Importantly, their inter-relationship changes as speed of the motor changes. The inter-dependence of the I_{q} and I_{d} control loops raises a problem. The motor winding impedance is an important aspect of the FOC control loop because it is this impedance that converts the inverter output voltage into motor current. The motor winding itself offers a complex impedance consisting primarily of resistance and inductance. For very low frequency, the impedance of the motor is effectively resistive only. At high frequency the impedance of the motor winding becomes essentially inductive only.

Referring to FIG. 1 and beginning with the very low speed condition, assume that the motor is running at a steady operating point delivering torque to a mechanical load at a mechanical speed that cause the motor winding to be resistive at fundamental frequency. In this case, a step change in the commanded torque current (I_{q}) will provide an immediate error at the Iq summing junction output, (i.e., I_{qerror}=I_{qstep}), which is then processed through the PI block, the Park⁻¹ and the Clark⁻¹ functions and ultimately produces a q-axis voltage (V_{q}) on the inverter output terminals, which in turn produces the desired increase in q-axis motor voltage. Because the motor is resistive, it converts the inverter q-axis voltage (V_{q}) into a q-axis, torque producing, current (I_{q}). The desired response in the q-axis current is achieved and the initial error generated by the I_{q} command step change is fully resolved through the q-axis loop alone.

By a similar process, a step change to the excitation current command (I_{d}) is processed through the d-axis control path resulting in a d-axis inverter voltage that is converted to a d-axis current by the motor winding resistance. The I_{d} command current is fully resolved by the d-axis control loop alone.

Transient response to disturbances on either the q-axis or d-axis is determined primarily by the PI functional block and the motor winding impedance. All other transfer functions in the block diagram are considered to have negligible effect for purposes of this application. The performance of the q-axis and d-axis loops can be independently tailored to the specific requirements for either control loop. While this is true for the above-described low motor speed operating condition, this basic FOC system provides substantial performance change and performance limitations at higher motor speeds.

As mentioned, the motor winding impedance becomes inductive at higher speeds. The transition from resistive to inductive impedance is a function of the motor winding resistance (R) and inductance (L) and it occurs at an electrical frequency:
F₀=ω₀/2π,
where ω₀=R/L, and where F₀ is expressed in units of Hz.

By way of a specific example, a 4-pole, 40,000 rpm, 100 horsepower, permanent magnet motor for an aircraft hydraulic pump application (or for a compressor application) might typically have an inductance L=100 uH and a resistance R=0.010 ohms giving F₀=16 Hz. This is equivalent to 480 rpm for the 4-pole motor. Operating substantially above this speed, for example at 160 Hz or 4800 rpm, the motor impedance is effective inductive, i.e.:
Zₘₒₜₒᵣ=R+j2π*160=0.010+j0.10≈0.10/90° ohms (i.e. 0.1 ohms at 90 degrees)

At 16 Hz the motor impedance is found to be ≈0.014/45° ohms, and at 1.6 Hz is found to be ≈0.010/0° ohms.

Again, referring to FIG. 1, assume that the motor is running at a steady state speed and associated fundamental electrical frequency where the motor impedance is primarily inductive. In this case, a step change in the commanded torque current (I_{q}) will provide an immediate error at the q-axis summing junction output, (i.e., I_{qerror}=I_{qstep}), which is processed through the PI block, the Park⁻¹ and Clark⁻¹ functions and produces a q-axis voltage (V_{q}) on the inverter output, which in turn, is applied to the motor winding. Because the motor is operating at a speed that causes it to be inductive, the current will lag the V_{q} voltage by some angle, which is for all intents and purposes, a positive d-axis component of current (I_{d}). The desired response has not been achieved, because the commanded I_{q} current has, in fact, created an I_{d} response in the motor current. For purposes of this example, the angle is taken to be 90°, although it should be understood that all angles between 0° and 90° have a similar and increasing problem.

This errant d-axis current (I_{d}) will next be sensed by the motor current sensors and then after being processed through the Park and Clarke transformations it will appear at the d-axis summing junction output, i.e., I_{d error}=−I_{d}. This negative I_{d} error current will be processed through the d-axis loop's PI block, then the Park⁻¹ and Clark⁻¹ functions and produce a negative d-axis voltage (−V_{d}) response in the inverter output, which in turn is applied to the motor winding. Because the motor is operating at a speed that causes it to be inductive, the current will lag the voltage by 90°, which is for all intents and purposes a positive q-axis component of current (I_{q}).

Thus, the initial error generated by the I_{q} command step change is finally resolved, but both the d-axis loop and the q-axis loop are fully involved in the resolution of the initial q-axis error. Unwanted errors (disturbances) were created in the d-axis control loop. Because both the d and q-axis paths are involved in a sequential manner, the q-axis control response has become a second order system response for motor frequencies substantially above ω₀. That is, the q-axis closed loop transfer function required both q and d-axis control steps (PI functions are effectively cascaded). FIG. 2 illustrates this problem as a vector diagram.

By a similar analysis, a step change to the I_{d} current command can be shown to be proceed sequentially through the d-axis and then the q-axis control loops path before the desired response in the motor's d-axis current is achieved. Similar to the q-axis control loop, the d-axis control loop transfer function also contains both q and d-axis PI control steps.

Thus, the conventional FOC control system has a substantially different closed loop transfer function for low speed operation as compared to that for high-speed operation. While the effect at both 0 degree and 90 degree is described, there would be a similar effect at all angles between the two. The amount of the phase shift would change with the changing angle, however, the basic disturbances as described would occur. Because both q-axis and d-axis control loops are sequentially involved, the control response will have a much different and perhaps undesired control response as compared to that for the low speed operation. It is generally undesirable to have two cascaded integrators in a closed loop control system, because together they will (by definition) create opportunity for 180 degree total phase shift and perhaps lead to control instability.

Because the conventional FOC system necessarily incorporates PI (proportional-integrator) functions in both q-axis and d-axis control loops, and because the motor impedance forces the system into a 2-pole closed loop system response as described above, the standard FOC system is potentially prone to control stability problems.

In normal control theory, a control “zero” can be used to compensation closed loop poles in an attempt to improve phase margin and stability. However, compensation techniques are less preferable than the complete elimination of a pole (when possible) because it results in a much more robust and predictable control system.

It is also known that electronic power converters with actively regulated outputs (which includes motor drives) exhibit a constant power characteristic at the power converter's input power terminals. As the “constant power” terminology implies, when the input DC voltage to the inverter/converter is disturbed, the input current will respond in the opposite sense, i.e., increasing the input voltage will elicit an input current decrease and conversely a decrease in input voltage will elicit an input current increase. This “negative resistance” effect is well known and will tend to “un-damp” any resonant circuits or filters connected to the (input) power bus and could lead to instability in the entire power system. One important method is to limit the “bandwidth” of the constant power feature in the control algorithm to a sufficiently low level, generally well below the lowest corner frequency of any resonant circuits connected to the power bus. In this manner, any un-damping effects will fall outside any potential areas of resonance. Constant power bandwidth limiting can be provided in an FOC motor drive system by using the pole (integrator) provided in the PI (proportional-integrator) functional block. Thus, it is desired to have a single control loop “pole” for power system stability reasons, but no more than a single pole for control stability reasons as discussed above.

### SUMMARY OF THE INVENTION

In a disclosed feature of this invention, the time derivative of the motor position angle (that is, the rotational speed or electrical frequency) is utilized to determine the expected disturbance angle or phase shift angle resulting from the motor's impedance angle. An ARCTAN function provides that impedance angle which is then summed with the motor rotor position angle and this sum is fed into the inverse Park component. The angle provided by this ARCTAN function will effectively compensate for the motor impedance angle. Thus, and even as the motor becomes more inductance-based at higher frequencies, the disturbance described in the Background of the Invention section will not occur.

The ARCTAN function can be imposed directly at the inverse Park transformation, or at an upstream or downstream location.

These and other features of the present invention can be best understood from the following specification and drawings, the following of which is a brief description.

### BRIEF DESCRIPTION OF THE DRAWINGS

FIG. 1 shows a prior art motor control.

FIG. 2 is an electrical phasor diagram of a motor associated with the prior art motor control.

FIG. 3 shows a first embodiment of the present invention.

FIG. 4 shows a second embodiment of the present invention.

FIG. 5 shows an electrical phasor diagram for a motor associated with the inventive controls.

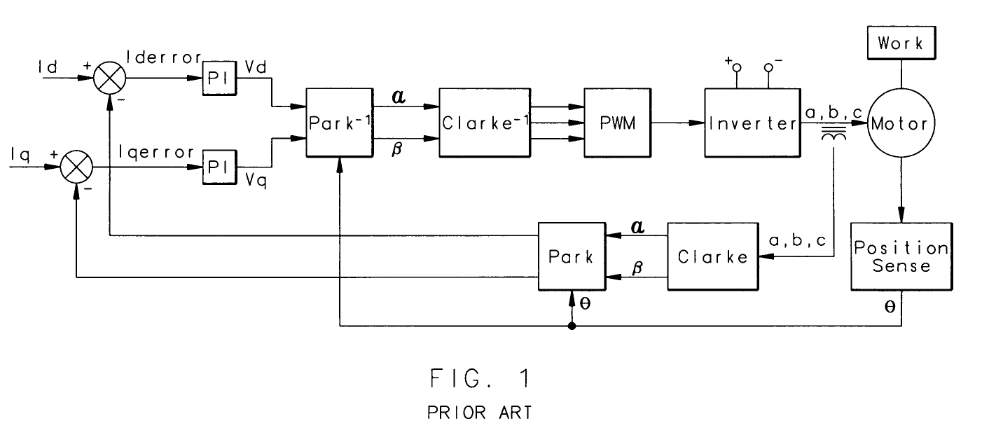

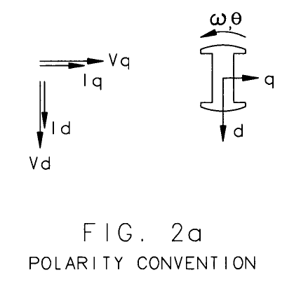

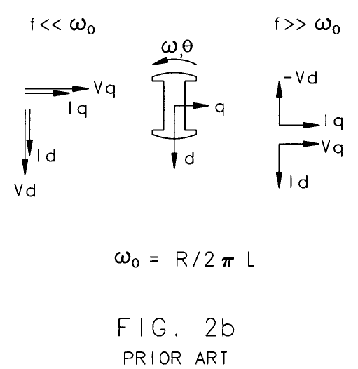

### DETAILED DESCRIPTION OF THE PREFERRED EMBODIMENT

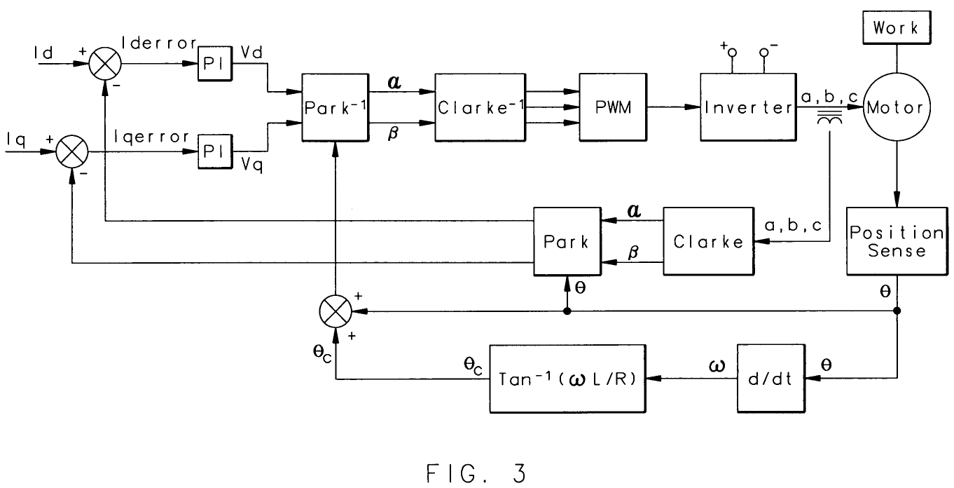

FIG. 3 illustrates a disclosed control. The basic configuration of the conventional FOC algorithm is retained. However, an ARCTAN function (Tan⁻¹) is added that provides a phase shifting angle in response to motor rotational speed (electrical frequency). Specifically, the ARCTAN function provides an angle precisely equal to the motor winding impedance angle. As can be appreciated from FIG. 3, the ARCTAN function receives the time derivative of the sensed angular position of the motor to determine the frequency, ω. This angle θ_{c}, output from the ARCTAN function, is used to rotate the inverse Park function (Park⁻¹) alone (that is not the forward Park function) with a polarity such that as the motor impedance angle changes from zero to +90 degrees, the input angle θ_{c} to the Park⁻¹ block will also change from 0 to +90 degrees. In this manner, the undesired effect of the motor impedance change over the operating speed range will be precisely eliminated. The end result is that for the entire operating speed range, both the q-axis and d-axis control loops will act independent from each other and eliminate the unwanted second closed loop pole that is encountered in the conventional FOC system at high speeds.

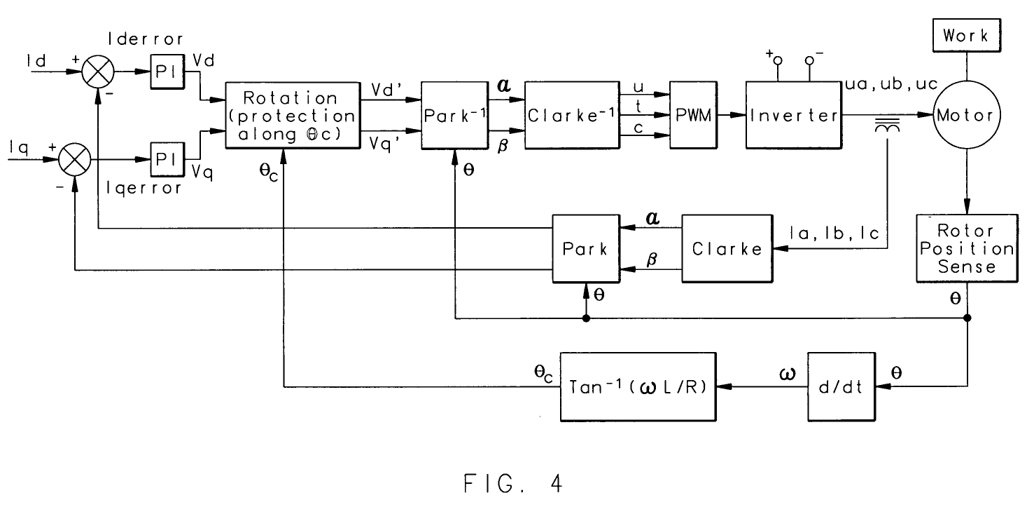

FIG. 4 shows another embodiment wherein the ARCTAN function is supplied to a rotation block. That is, in the FIG. 4 embodiment, the correction function is supplied upstream of the inverse Park transformation. However, the correction as described would occur in the same manner, as the correction function moves downstream and to the inverse Park transformation.

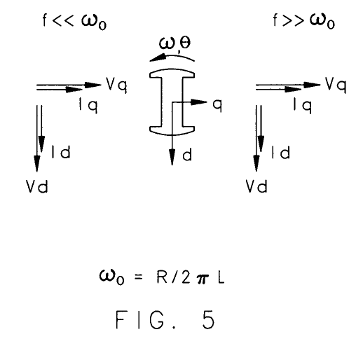

FIG. 5 shows the revised forces on the motor due to the correction of FIG. 3 or 4.

To illustrate the performance of the new control, consider the motor operating at a speed where the motor impedance is resistive (impedance angle is zero). Here, because ω is zero, the Tan⁻¹ function will provide no phase shift (θ_{c}=0°) and the system will function the same as the conventional system, that is each loop will act independently as described above for the resistive motor case.

For higher motor speeds, say where the motor impedance is +90° (inductive), the Tan⁻¹ function will add 90° to the Park⁻¹ function (θ_{c}=90°). Then a commanded step increase on the q-axis input (I_{q}) will cause a positive output on the q-axis summing junction (I_{qerror}=I_{qstep}), which will result in a q-axis voltage (V_{q}) on the output of the PI block. Because θ_{c}=90°, the Park⁻¹ block will advance the V_{q} phasor by 90° and this will effectively translate V_{q} into a negative V_{d} input to the Clark⁻¹ and PWM functions. The inverter will then generate a negative V_{d} voltage that when applied to the motor will (because of the inductive motor impedance) provide an immediate and desired q-axis loop without disturbing the d-axis loop and without the effects of the PI pole in the d-axis loop. That is, the cascading of poles inherent in the baseline FOC system, has been effectively eliminated.

By a similar argument, it can be shown that d-axis commands or disturbances will also traverse the d-axis loop only without traversing the q-axis loop.

While the effect at both 0 degree and 90 degree is described, there would be a related effect similar correction at all angles between the two. The amount of the phase shift would change with the changing angle, however, the basic correction of the disturbances as described would still occur, albeit with intermediate angles.

The end result is that the undesired second pole and associated second order response characteristic of the conventional FOC loop has been effectively eliminated without adding compensation “zeros” or other undesirable effects. The performance improvements are significant and have been demonstrated through hardware testing to eliminate previously encountered control stability problems. Also because the FOC loop is now a simple single pole control loop, the constant power control bandwidth can also be tailored with this single pole to assure good power system stability as well.

While the correction has been described functionally, a worker in the art would recognize how to incorporate the function into existing controls.

It should be understood that various alternatives to the embodiments of the invention described herein may be employed in practicing the invention. It is intended that the following claims define the scope of the invention and that the method and apparatus within the scope of these claims and their equivalents be covered thereby.

1. A motor controller for a motor receiving three-phase voltage power from an inverter, said motor controller comprising:
a sensor path for sensing the three-phase voltage supplied by the inverter to the motor, and a position sensor for sensing an angular position of the motor, said sensed three-phase voltage being sent through a feedback loop operable with a first transformation block to transform said sensed three-phase voltage into two components, and said two components being associated with two axes;
said controller including summing blocks for receiving said two components, and comparing said two components to desired components, and said controller including two separate loops for separately processing each of said two components back toward said inverter by passing through a second transmission block, for changing said two components back into three components; and
a control block for taking a frequency of operation of the motor, and feeding an ARCTAN function based on said frequency back into said second transformation circuit.

2. The motor controller as set forth in claim 1, wherein said first transformation block includes both a Clarke transformation and a Park transformation, and said second transformation block includes both a Clarke and a Park inverse transformation.

3. The motor controller as set forth in claim 2, wherein said function is fed back directly to said inverse Park transformation.

4. (canceled)

5. The motor controller as set forth in claim 2, wherein said function is fed back to a block upstream of said inverse Park transformation.

6. The motor controller as set forth in claim 1, wherein a differentiator differentiates an angle sensed by an angular position sensor to determine the frequency of operation of said motor, said frequency being utilized to determine said function.

7. (canceled)

8. The motor controller as set forth in claim 1, wherein a summation block receives both said ARCTAN function, and an angular position of said motor at a summation block, an output of said summation block being delivered to said second transformation block.

9. A motor and controller comprising:
a motor being driven by a three-phase voltage source, three-phase voltage being supplied to said motor by an inverter, and a feedback loop including a controller for controlling the three-phase voltage supplied from said inverter to said motor, said controller comprising:
a sensor path for sensing said three-phase voltage supplied by the inverter to the motor, and a position sensor for sensing an angular position of the motor, said sensed three-phase voltage being sent through a feedback loop operable with a first transformation block to transform said sensed three-phase voltage into two components, and said two components being associated with two axes;
said controller including summing blocks for receiving said two components, and comparing said two components to desired components, and said controller including two separate loops for separately processing each of said two components back toward said inverter by passing through a second transmission block, for changing said two components back into three components; and
a control block for taking a frequency of operation of the motor, and feeding an ARCTAN function based on said frequency back into said second transformation circuit.

10. The motor and controller as set forth in claim 9, wherein said first transformation block includes both a Clarke transformation and a Park transformation and said second transformation block includes both a Clarke and a Park inverse transformation.

11. The motor and controller as set forth in claim 10, wherein said function is fed back directly to said inverse Park transformation.

12. (canceled)

13. The motor and controller as set forth in claim 10, wherein said function is fed back to a block upstream of said inverse Park transformation.

14. The motor and controller as set forth in claim 9, wherein a differentiator differentiates an angle sensed by an angular position sensor to determine a frequency of operation of said motor, said frequency being utilized to determine said function.

15. (canceled)

16. The motor and controller as set forth in claim 9, wherein a summation block receives both said ARCTAN function, and an angular position of said motor at a summation block, an output of said summation block being delivered to said second transformation block.

17. The motor and controller as set forth in claim 9, wherein said motor is utilized to drive an aircraft-based component.

18. A method of controlling a motor comprising the steps of:
supplying a three-phase voltage to a motor, and providing feedback of said three-phase voltage through a feedback path, and including a first step of transforming said feedback of three-phase voltage into a pair of components associated with two axes;
sensing an angular position of the motor, and taking the time derivative of said sensed angular position, and applying said time derivative to a function block for providing a correction function based upon said time derivative of said angular position;
supplying said two components and said correction function to a second step of transforming for changing said two components back into three correction components to be supplied back to said inverter.

19. The method as set forth in claim 18, wherein said correction function is the ARCTAN of the frequency.

20. The motor controller as set forth in claim 1, wherein said ARCTAN function provides an indication of a motor impedance angle, to correct for potential errors at an output of said second transmission block.

21. The motor controller as set forth in claim 20, wherein said motor impedance angle is calculated identically.

22. The motor controller as set forth in claim 9, wherein said ARCTAN function provides an indication of a motor impedance angle, to correct for potential errors at an output of said second transmission block.

23. The motor controller as set forth in claim 22, wherein said motor impedance angle is calculated identically.

24. The method as set forth in claim 18, wherein said correction function provides an indication of a motor impedance angle to said second step.

25. The method as set forth in claim 24, wherein said correction function provides an identical calculation of said motor impedance angle.
